(19) United States
(12) Patent Application Publication
(10) Pub. No.: US 2017/0194123 A1
(43) Pub. Date: Jul. 6, 2017

(54) SHIFTING DEVICE

(71) Applicant: EATON INDUSTRIES (AUSTRIA) GMBH, Schrems (AT)

(72) Inventors: Adolf TETIK, Vienna (AT); Nikola BOJANIC, Vienna (AT)

(73) Assignee: EATON INDUSTRIES (AUSTRIA) GMBH, Schrems (AT)

(21) Appl. No.: 15/312,185

(22) PCT Filed: May 19, 2015
(86) PCT No.: PCT/EP2015/060988

§ 371 Date: Feb. 8, 2017

(30) Foreign Application Priority Data
May 22, 2014 (DE) 10 2014 107 265.0

(51) Int. Cl. H01H 71/52; H01H 5/04; H01H 71/04; H01H 71/12

(52) U.S. Cl. CPC H01H 71/526; H01H 71/128; H01H 5/04; H01H 71/04

(57) ABSTRACT

A shifting device has a contact which is fixed to the housing; a movable contact; a shift lock which has a latch and a latch support, the latch support having a latching point for latching the latch to the latch support; a manual shifting lever which is connected to the latch using a first bracket in order to contact the movable contact with the contact that is fixed to the housing; and a sudden disconnect mechanism for manually causing a sudden separation of the contacts, the manual shifting lever additionally having a second bracket such that an actuation of the manual shifting lever releases the latch connection between the latch support and the latch in order to separate the movable contact from the contact which is fixed to the housing.

### CROSS-REFERENCE TO RELATED APPLICATIONS

This application is a U.S. national stage application under 35 U.S.C. §371 of International Application No. PCT/EP2015/060988, filed on May 19, 2015, and claims benefit to German Patent Application No. DE 10 2014 107 265.0, filed on May 22, 2014. The International Application was published in German on Nov. 26, 2015, as WO 201 5/1 771 44 A1 under PCT Article 21(2).

### FIELD

The invention relates to a switching device including a fixed contact and a movable contact.

### BACKGROUND

In most low-voltage switching devices that have a manual control knob, i.e. a manually operated element for closing the switch contacts and forming a conducting current path through the switching device, a movable switch contact mechanically coupled to the manual control knob is steadily brought closer to a switch contact fixed to the housing by means of the movement of the manual control knob until the two switch contacts mechanically abut one another. Accordingly, the contacts are opened, i.e. the switching device is deactivated, by moving the relevant manual control knob in a corresponding direction, resulting in the contacts being likewise separated steadily. By holding the manual control knob in any intermediate position, a user may even be able to keep the contacts in a corresponding intermediate position.

If there is an electric potential applied to the switching device in question, an arc is formed if the two switch contacts are close enough together. If the voltage is sufficiently low and as long as only loads that cause just a small flow of current over the switching device are connected, this generally does not cause any problems.

However, at higher DC voltages or higher DC currents, for example 600 V and 100 A, an arc of this kind, produced by the contacts being manually separated too slowly, can lead to significant damage to the switching device in question. If an accordingly higher current flows over the switching device in question as it is being switched off, the arc formed by the contacts being opened too slowly can not only lead to total failure of the switching device in question, but can also cause a fire.

Switching devices comprising a “snap-action deactivation function” are known. In these, when the device is switched off manually, the switch contacts are separated abruptly, regardless of how or how quickly a user operates a manual control knob. However, snap-action deactivation functions of this kind are common predominantly in the field of very large circuit breakers, as used for example in substations. Switching devices of this kind comprise spring accumulators that can be loaded separately and are used to close or open the contacts, but it is almost impossible to use this technology in the field of compact switching devices because the relevant technology cannot be integrated in the compact housings.

### SUMMARY

An aspect of the invention provides a switching device, comprising: a fixed contact, fixed to a housing, and a movable contact, the movable contact being arranged on a contact arm movably arranged in the switching device, the movable contact being configured to contact the fixed contact and being configured to form a conducting current path through the switching device; a latch, connected to the contact arm, the latch including a pawl and a pawl bearing surface, the pawl bearing surface including a latching point configured to latch the pawl to the pawl bearing surface; a hand lever, connected to the pawl using a first yoke, configured to bring the movable contact into contact with the fixed contact a snap-action deactivation mechanism configured for abrupt separation of the fixed and movable contacts following manual actuation; and a second yoke, mounted on the hand lever in such a way that actuation of the hand lever for separating the movable contact from the fixed contact releases the latching between the pawl bearing surface and the pawl.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a vertical section through a preferred embodiment of switching device according to the invention, without the upper housing shell, in the deactivated state;

FIG. 2 is a vertical section through the switching device according to FIG. 1, in the activated state without adjusting springs;

FIG. 3 is an axonometric view of the assembly of the latch, contact arm, snap-action activation mechanism and hand lever of the switching device according to FIG. 1;

FIG. 4 is a vertical section through the assembly according to FIG. 3 in the deactivated state;

FIG. 5 shows the view according to FIG. 3, without adjusting springs;

FIG. 6 shows the assembly according to FIG. 5 with the snap-action rocker in a partially cut-away view, in a state shortly before the contacts are closed, without adjusting springs;

FIG. 7 shows the assembly according to FIG. 5 with the contacts closed and without adjusting springs;

FIG. 8 is an axonometric view of the snap-action rocker of a switching device according to the invention;

FIG. 9 is a partially cut-away view of the outline of the snap-action rocker according to FIG. 8;

FIG. 10 is an axonometric view of the contact arm, formed as a switching bridge, of a switching device according to the invention;

FIG. 11 is a vertical section through the switching device according to FIG. 1, comprising a snap-action deactivation mechanism;

FIG. 12 is an axonometric view of the assembly of the latch, contact arm, snap-action activation mechanism, snap-action deactivation mechanism and hand lever of the switching device according to FIG. 11;

FIG. 13 is a vertical section of the assembly according to FIG. 12, in the deactivated state;

FIG. 14 shows the view according to FIG. 13, with the snap-action rocker in a partially cut-away view;

FIG. 15 shows the assembly according to FIG. 13, with the snap-action rocker in a partially cut-away view, while the snap-action activation mechanism is holding the contact arm;

FIG. 16 shows the assembly according to FIG. 13, with the snap-action rocker in a partially cut-away view, in a state shortly before the contacts are closed;

FIG. 17 shows the assembly according to FIG. 13 with the contacts closed, showing the latching point in a partially cut-away view, the catch projection and the rocking lever;

FIG. 18 shows the assembly according to FIG. 17, the hand lever moving toward the contact opening whilst the latching is still active;

FIG. 19 shows the assembly according to FIGS. 17 and 18 in the deactivated state;

and

FIG. 20 is an exploded view of the hand lever.

### DETAILED DESCRIPTION

Therefore, an aspect of the invention provides a switching device of the type mentioned at the outset by which the aforementioned disadvantages can be prevented and which allows the switching device to be switched off safely, has a compact design and is simple to produce.

As a result, the switching device can be switched off safely, i.e. the contacts can be separated safely, regardless of the speed at which a user operates the hand lever. The switching device in question can be designed having compact dimensions and has a smaller number of necessary parts.

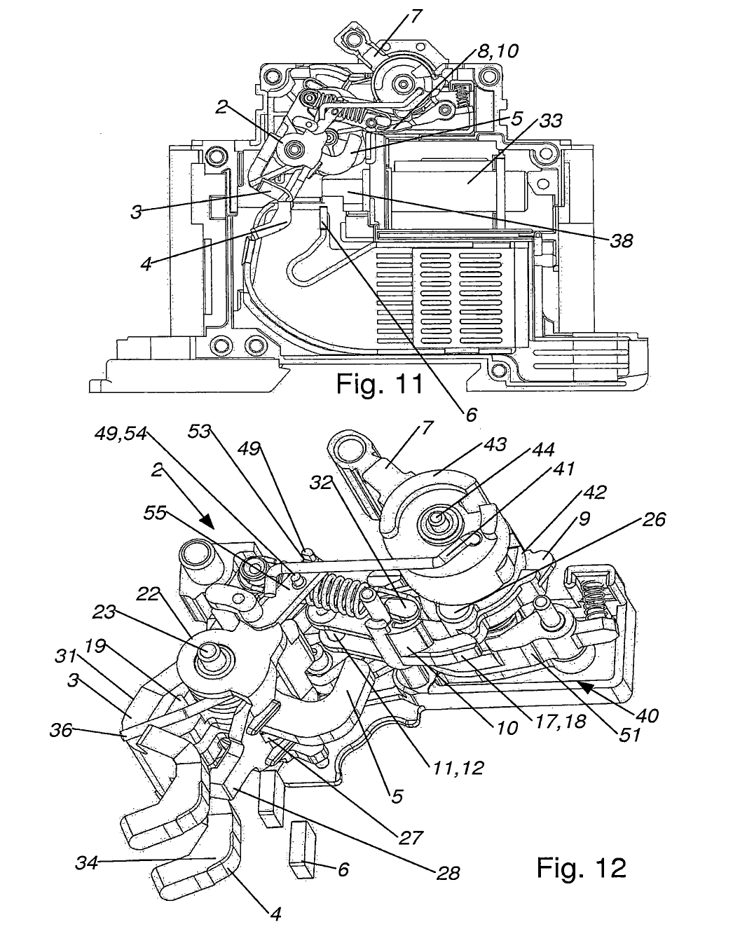

FIG. 11 shows a switching device 1, in particular a protective switching device, comprising a contact 6 fixed to the housing and a movable contact 4, the movable contact 4 being arranged on a contact arm 3 movably arranged in the switching device 1, the movable contact 4 being intended for contacting the contact 6 fixed to the housing and for forming a conducting current path through the switching device 1, the switching device 1 comprising a latch 2 that is connected to the contact arm 3, the latch 2 comprising a pawl 20 and a pawl bearing surface 22, the pawl bearing surface 22 comprising a latching point 24 for latching the pawl 20 to the pawl bearing surface 22, the switching device 1 further comprising a hand lever 7, which hand lever 7 is connected to the pawl 20 by means of a first yoke 37 in order to bring the movable contact 4 into contact with the contact 6 fixed to the housing, the switching device 1 comprising a snap-action deactivation mechanism 40 for the abrupt separation of the contacts 4, 6 following manual actuation, wherein a second yoke 41 is further mounted on the hand lever 7 in such a way that operation of the hand lever 7 for separating the movable contact 4 from the contact 6 fixed to the housing releases the latching between the pawl bearing surface 22 and the pawl 20.

As a result, the switching device 1 can be switched off safely, i.e. the contacts 4, 6 can be separated safely, regardless of the speed at which a user operates the hand lever 7. The switching device 1 in question can be designed having compact dimensions and has a smaller number of necessary parts.

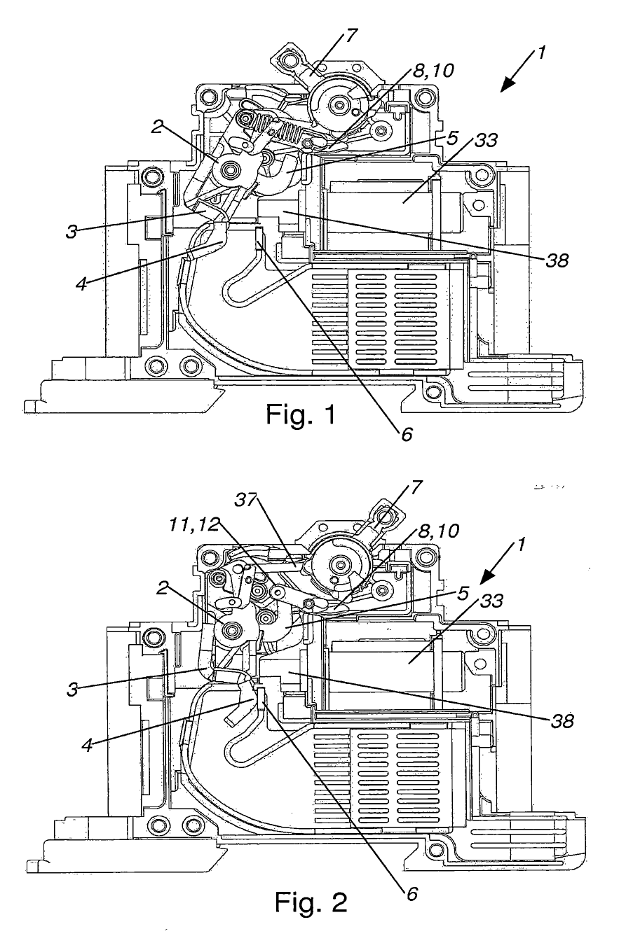

The invention being described here relates to an electrical switching device 1, the switching device 1 preferably being designed as a protective switching device or what is known as an automatic circuit breaker. Preferably, the switching device 1 is formed as a miniature circuit breaker or a power switch. Preferably, the switching device 1 is formed as a compact low-voltage protective switching device. According to the preferred design, the switching device 1 preferably comprises at least one trip 33. FIGS. 1 and 2 both show an electromagnetic trip 33, for example a short-circuit trip. Additionally, a thermal trip formed in the known manner can also be provided, for example a bimetal trip for overcurrent tripping. The trips 33 in question can also be combined.

The switching device 1 comprises at least one movable contact 4 and at least one contact 6 fixed to the housing. According to the preferred embodiment shown, the switching device 1 comprises a “double break”, and thus comprises two movable contacts 4 and two contacts 6 fixed to the housing, which are nevertheless assigned to just one contact gap.

When the at least one movable contact 4 is connected in an electricity-conducting manner to the at least one contact 6 fixed to the housing, there is an electricity-conducting current path through the switching device 1. The switching device 1 comprises connection terminals (not shown). If there is no such electricity-conducting connection through or over the switching device 1, this is described as deactivated or the deactivated state. If the corresponding conductive connection is produced, this is described as activated or the activated state. Accordingly, and as is normal, the transitions between the two states are referred to as activation and deactivation of the switching device 1. Closed contacts 4, 6 can be used synonymously for activated, as can open contacts 4, 6 for deactivated.

The at least one movable contact 4 is arranged on a movable contact arm 3. According to the preferred embodiment, the contact arm 3 shown separately in FIG. 10 comprises two movable contacts 4 arranged in each case on parallel prong-like extensions 34 of the contact arm 3, which can also be referred to as a contact bridge or switching bridge in this embodiment.

On an end facing away from the at least one movable contact 4, the contact arm 3 comprises a contact arm extension 5, which is hook-shaped according to the preferred embodiment. According to the preferred embodiment, an end region 30 of the contact arm extension 5 is arranged substantially in parallel with a central piece 31 of the contact arm 3. Different angles can be provided according to the structural details of the switching device 1 in question.

Furthermore, the contact arm 3 comprises a bearing point 35 that is arranged between the at least one movable contact 4 and the contact arm extension 5 and is preferably in the form of a through-hole.

The contact arm 3 is designed as a part through which current flows directly, preferably comprising a copper-based alloy. According to the embodiment shown, the contact arm 3 is substantially a single piece, only the two movable contacts 4, as bearing surfaces, being made of a suitable contact material. The contact arm 3 can also be in multiple parts, and only the regions of the contact arm 3 through which current flows directly are designed comprising a highly conductive copper alloy, whilst the contact arm extension 5 is made of a different material. In practice, single-piece contact arms 3 have proven particularly successful in terms of both economical production and rigid construction.

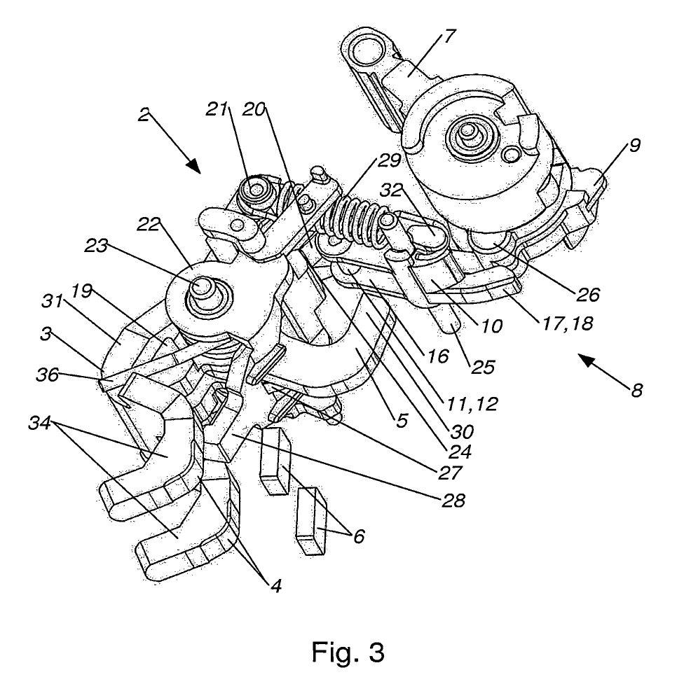

The switching device 1 comprises what is known as a latch 2. The latch 2 is a mechanical assembly that controls the movements of the contact arm 3. In the preferred and shown embodiment, the latch 2 also comprises, in addition to the contact arm 3, a contact arm support 19, a pawl 20 and a pawl bearing surface 22. FIG. 3 is an axonometric view of the corresponding sub-assemblies separated from the other components of the switching device 1, in the deactivated state.

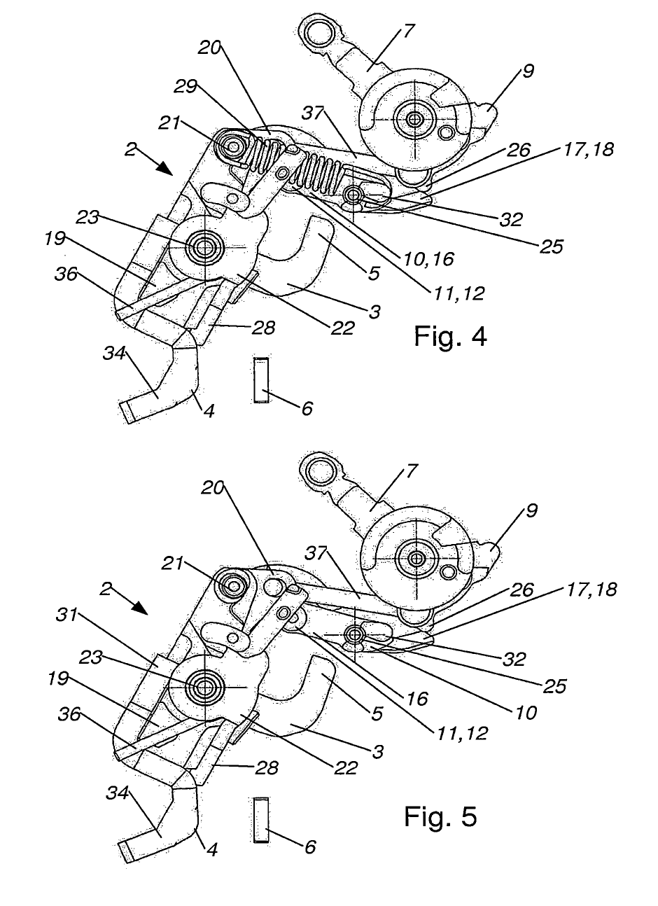

The contact arm support 19, the contact arm 3 and the pawl bearing surface 22 are mounted in the latch 2 so as to be movable about a common latch rotary spindle 23, and each comprise corresponding through-holes or bearing points. The three parts are each arranged so as to be movable relative to one another. According to the embodiment shown, between the contact arm support 19 and the contact arm 3 there are arranged two leg springs 36 which cause the contact pressure when the contacts 4, 6 are closed and push the contact arm 3 against the contact arm support 19 when the contacts 4, 6 are open, as shown in FIGS. 4 and 5. When the contacts 4, 6 are closed, the contact arm 3 is lifted off the contact arm support 19 in some regions, as shown in FIG. 7. The pawl 20 can also be referred to as a detent lever.

The pawl 20 is mounted on the contact arm support 19 so as to be movable about a pawl rotary spindle 21. The pawl 20 is connected to the hand lever 7 of the switching device 1 by means of a yoke 37 or a rod. The first yoke 37 can also be referred to or formed as a push rod.

The pawl bearing surface 22 comprises a latching point 24 for connecting to the pawl 20. In the “latched” state, i.e. when the pawl 20 engages on the pawl bearing surface 22, starting from a deactivated state of the switching device 1 movement of the hand lever 7 is transmitted to the pawl 20 by means of the first yoke 37. Since the pawl 20 cannot move or pivot away owing to the latching, the contact arm support 19 and the contact arm 3 are also moved as a result of the movement of the hand lever 7.

The pawl bearing surface 19 further comprises a window 27, through which the contact arm extension 5 reaches, and also a tripping extension 28 arranged in the switching device 1 opposite the tripping pusher 38 of the trip 33, as shown for example in FIGS. 1 and 2. As a result of the pawl bearing surface 19 moving, i.e. by the tripping pusher 38 striking the tripping extension 28, the latching between the pawl 20 and the pawl bearing surface 19 can be released, leading to the contacts 4, 6 opening.

According to the particularly preferred embodiment, the switching device further comprises a snap-action activation mechanism 8. FIGS. 1 and 2 show a switching device 1 formed in this manner, the snap-action deactivation mechanism 40 not being shown in these illustrations.

By means of the snap-action activation mechanism 8 being described here, the proper functioning of the snap-action activation function can be reliably ensured over a long period of time or over a large number of activation operations. This can ensure that closing the contacts 4, 6, i.e. activating the switching device 1, leads to abrupt closure of the contacts 4, 6. In this way, the snap-action activation function can be carried out for many activation operations without noticeable changes. Since the contact arm catcher 11 does not have a lower hardness or surface hardness than the contact arm extension 5, signs of wear and tear, in particular loss of material, on the snap-action rocker can be prevented or reduced in such a way that the snap-action activation function is not affected. This can prevent material loss causing the retaining point of the snap-action activation mechanism 8 to constantly move until the snap-action rocker 10 can no longer firmly hold the contact arm extension 5 and the snap-action activation mechanism 8 becomes ineffective.

Above, it was described how, in the latched state, moving the hand lever 7 resulted in movement of the contact arm 3 and thus of the at least one contact. To prevent said parts continuously moving closer together, a snap-action activation mechanism 8 is provided, which firmly holds the contact arm 3 when the at least one movable contact 4 moves closer, in a predetermined manner, to the corresponding contact 6 fixed to the housing whilst the movement of the hand lever 7 continues. FIGS. 4 and 5 each show the relevant components in the deactivated state.

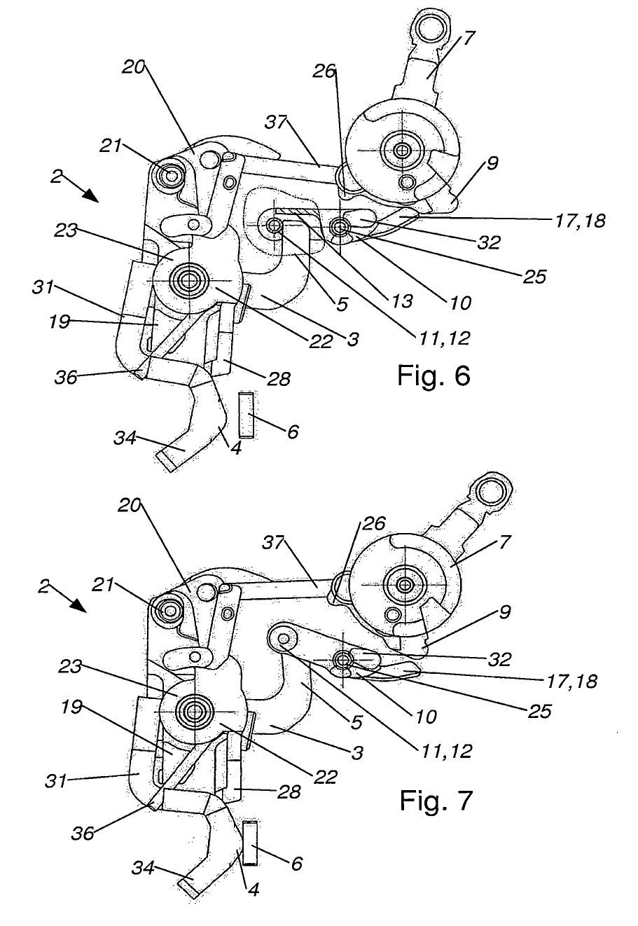

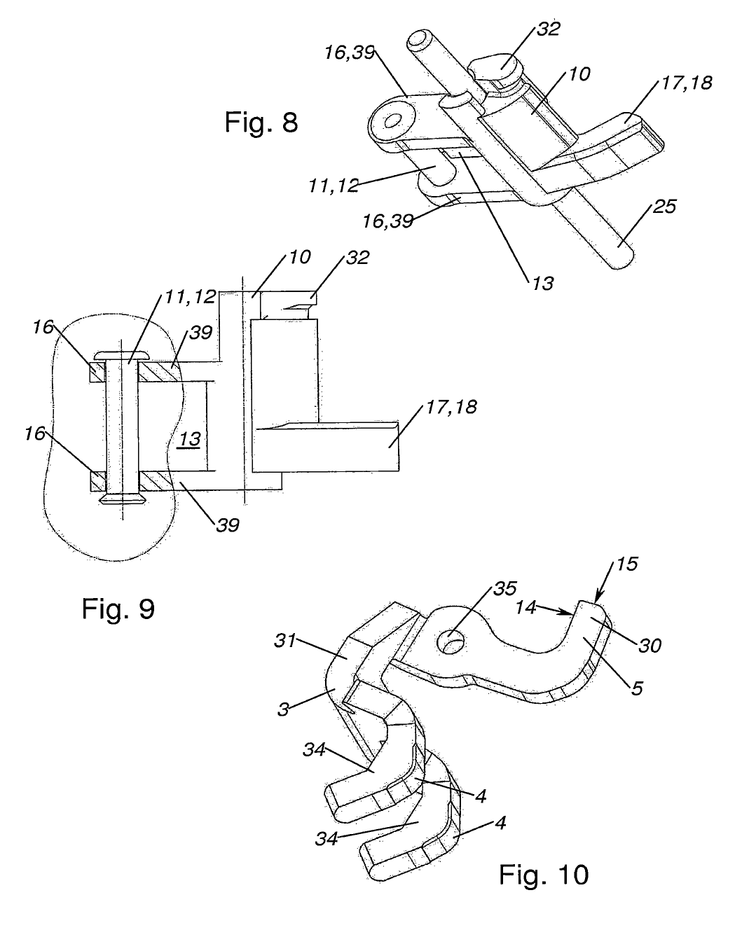

FIG. 6 shows a position in which the contact am 3 is held firmly. In this figure, the contacts 4, 6 are at an insulating distance from one another, at which there should be no arcing. When the hand lever 7 passes a particular position, this insulating distance is abruptly bridged and the contacts 4, 6 are closed. This can prevent the formation of an arc that is produced for a long enough time to damage the switching device 1. The abrupt closure of the contacts 4, 6 can also ensure that the necessary contact pressure is provided rapidly and is not just built up slowly, and can prevent any contact bouncing.

The snap-action activation mechanism 8 comprises a snap-action rocker 10 that is mounted in the switching device 1 so as to be rotatable about a snap-action rocker rotary spindle 25. The snap-action rocker 10 comprises a contact arm catcher 11, which is intended or designed to contact the contact arm extension 5. In this case, the contact arm catcher 11 temporarily holds the contact arm extension 5 firmly at the insulating distance, and then releases it in a predeterminable manner. For this purpose, the snap-action rocker 10 is controlled by a first cam 9 of the hand lever 7, the hand lever 7 further comprising a second cam 26.

According to the embodiment shown, the snap-action rocker 10 is formed as a lever, the contact arm catcher 11 being arranged on a first lever arm 16 of the snap-action rocker 10, and a second lever arm 17 of the snap-action rocker 10, as an actuation extension 18, being designed to contact the at least one first cam 9 of the hand lever 7.

The snap-action rocker 10 is connected to the contact arm support 19 by means of an adjusting spring 29. In this case, the adjusting spring 29 in question, which is preferably in the form of a helical tension spring, engages on the snap-action rocker 10 on a pin 32 arranged slightly eccentrically. When the hand lever 7 is in the deactivated position, the second cam 26 pushes the second lever arm 17 of the snap-action rocker 10, and pushes the contact arm catcher 11 away from the contact arm extension 5. The adjusting spring 29 is substantially tension-free in this position. By moving the hand lever 7 toward the activated position, the second cam 26 is moved away from the second lever arm 17, making it possible for the snap-action rocker 10 to pivot. At the same time, the adjusting spring 29 is tensioned since the contact arm support 19 is moved away. As a result of the force now applied by the adjusting spring 29 and since it is able to move, the first lever arm 16 of the snap-action rocker 10, which arm carries the contact arm catcher 11, pivots toward the contact arm extension 5, which is likewise moving toward said arm, and the two then come to abut one another.

If the movement of the hand lever 7 continues, there is no longer any movement of the contact arm 3, which is held firmly on the contact arm catcher 11 by means of the contact arm extension 5. FIG. 6 shows the corresponding position of the latch 2 or the snap-action activation mechanism 8. If the hand lever 7 is moved further in the direction for activating the switching device 1, the contact arm support 19 is moved further, resulting in the leg springs 36 being tensioned further and the contact arm 3 “lifting off” the contact arm support 19 in some regions. If the hand lever 7 is accordingly moved further, the first cam 9 reaches the region of the second lever arm 17 of the snap-action rocker 10. In succession, the first cam 9 pushes the contact arm catcher 11 away from the contact arm extension 5, whereby the contact arm 3 is released and the contacts 4, 6 close abruptly.

In this case, the contact arm 3 preferably abuts the contact arm catcher 11 by means of a first contact arm retaining surface 14.

The contact arm catcher 11 has a surface hardness that is greater than or equal to a surface hardness of the contact arm extension 5, in particular of the first contact arm retaining surface 14. The surface hardness of the contact arm catcher 11 is thus at least as high as the surface hardness of the contact arm extension 5. In this respect, the surface hardness or simply the hardness refers to the resistance with which the bodies in question or the surfaces thereof counteract the penetration of a testing element. Owing to the hardness of the contact arm catcher 11 compared with the contact arm extension 5, it is possible to prevent excessive wear to the contact arm catcher 11.

In terms of the surface hardness of the contact arm extension 5, the regions or portions of the contact arm extension 5 that are in contact with the contact arm catcher 11 or come into contact therewith during operation have the corresponding surface hardness compared with the contact arm catcher 11.

Preferably, the hardness or surface hardness in question results from the Vickers hardness testing method.

In particular, the contact arm catcher 11 is designed comprising metal, the contact arm catcher 11 particularly being designed comprising steel.

Preferably, the contact arm catcher 11 is substantially rotationally symmetrical, thus allowing the contact arm extension 5 to slide off the contact arm catcher 11 in an effective and low-friction manner. In this respect, it has proven advantageous to form the contact arm catcher 11 as a round rivet and/or a tubular rivet 12. According to the particularly preferred embodiment shown of a switching device 1, the contact arm catcher 11 is formed as a tubular rivet 12 made of steel. In addition to being simple to produce, a rivet of this kind also has high dimensional stability, thus making it possible to prevent the insulating distance shifting over many switching cycles.

It is particularly preferable, and particularly simple when the contact arm catcher 11 is formed as a round rivet and/or a tubular rivet 12, for the contact arm catcher 11 to be mounted in the snap-action rocker 10 so as to be rotatable about its own contact arm catcher spindle. The contact arm extension 5 thus rolls along the contact arm catcher 11, whereby the durability of the assembly can be increased further.

Preferably, the end region 30 of the contact arm extension 5 has a rounding in the region intended to abut the contact arm catcher 11 when said extension is released. This can further reduce the wear to both the contact arm extension 5 and the contact arm catcher 11.

When the contact arm extension 5 is hook-shaped, as is preferred, the contact support extension 5 preferably engages behind the contact arm catcher 11 when the two parts are engaged. In the process, the contact arm catcher 11 is designed accordingly to allow such engagement from behind. Accordingly, the contact arm catcher 11 preferably has a bar-like construction that links two side legs 39 of the snap-action rocker 10. This is provided when the contact arm catcher 11 is rotationally symmetrical, as is preferred and as shown in the drawings. In this case, the contact support extension 5 engages behind the contact arm catcher 11.

Preferably, the snap-action rocker 10 also comprises a limit stop 13 in the region of the contact arm catcher 11, and, when the contact arm extension 5 engages with the snap-action rocker 10, the first contact arm retaining surface 14 abuts the contact arm catcher 11 and a second contact arm retaining surface 15 abuts the limit stop 13. In the process, the second contact arm retaining surface 15 is arranged substantially normally to the first contact arm retaining surface 14. The limit stop 13 prevents the contact arm extension 5 entering the snap-action rocker 10 too far or too deeply. This can further ensure the intended function of the snap-action activation.

The switching device comprises a snap-action deactivation mechanism 40 for the abrupt separation of the contacts 4, 6 following manual actuation. In this case, the snap-action deactivation mechanism 40 comprises a second yoke 41, which can also be formed or referred to as a push rod or rod, similarly to the first yoke 37, and which second yoke 41 is mounted on the hand lever 7. The second yoke 41 interacts with the pawl bearing surface 22 in such a way that the latching between the pawl bearing surface 22 and the pawl 20 is released when the hand lever 7 is operated to separate the contacts 4, 6.

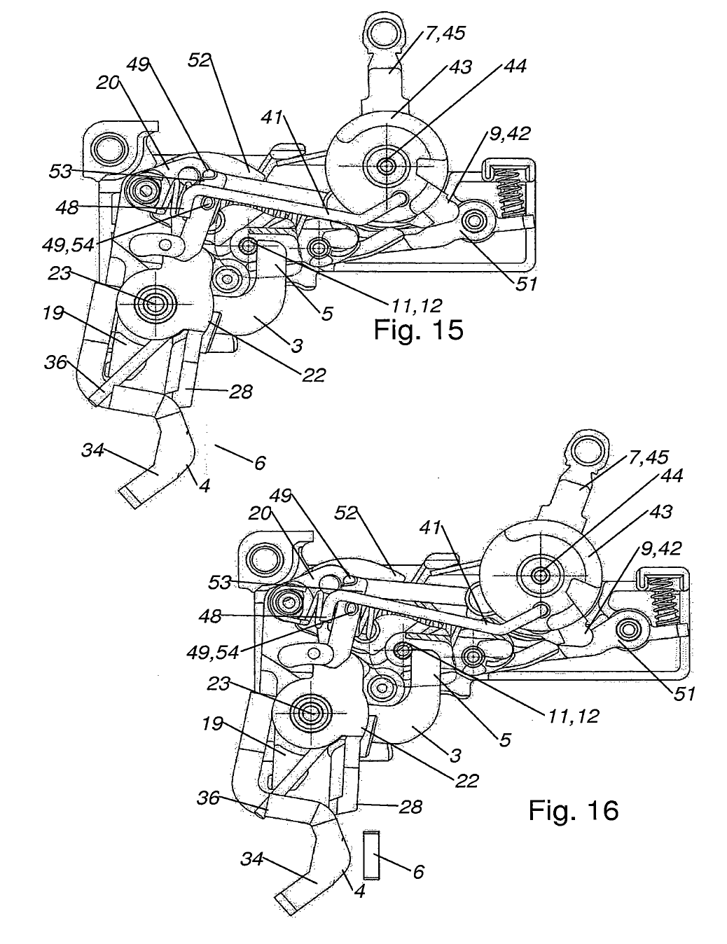

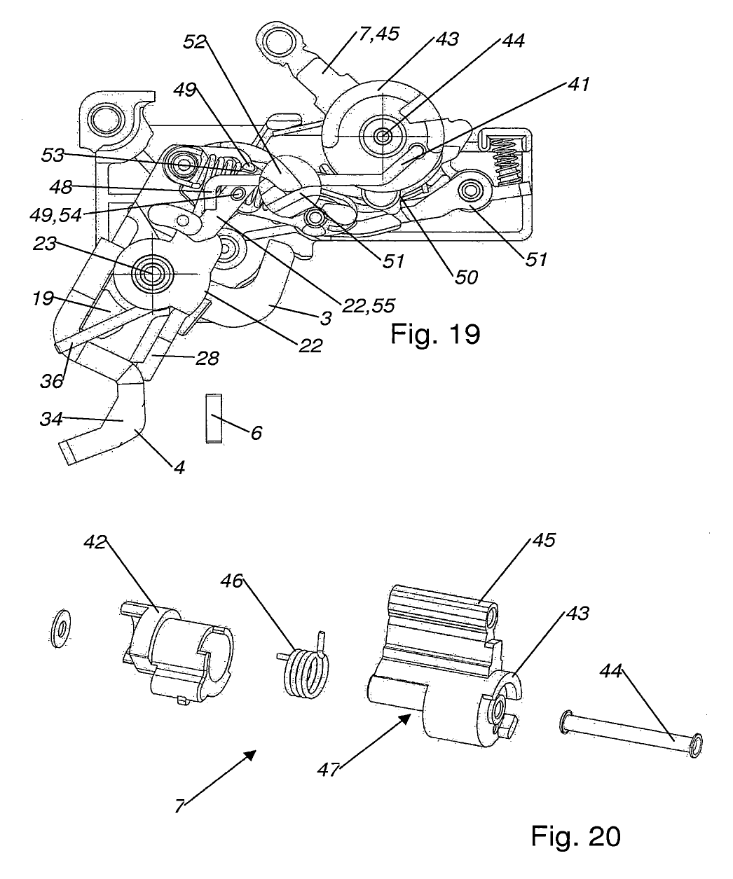

In this respect, FIGS. 11 to 19 show the accordingly designed switching device 1, comprising the snap-action deactivation mechanism 40, at least parts of the snap-action activation mechanism 8 also being shown.

Starting from a position corresponding to the activated state of the switching device 1, the hand lever 7 in question is moved toward a position corresponding to the deactivated state of the switching device 1, the second yoke 41 moving the pawl bearing surface 22 in such a way that the latching between the pawl 20 and the pawl bearing surface 22 is released. The latch 2 in question is thus “tripped” by means of the second yoke 41 since the second yoke 41 moves the pawl bearing surface 22 according to an actuation by the tripping pusher 38 of the trip 33.

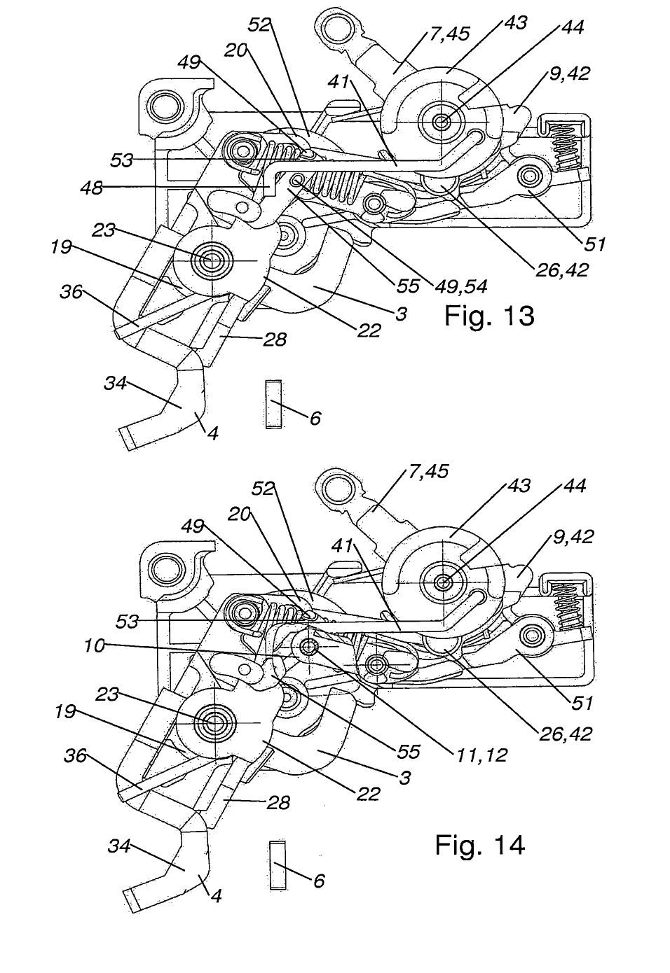

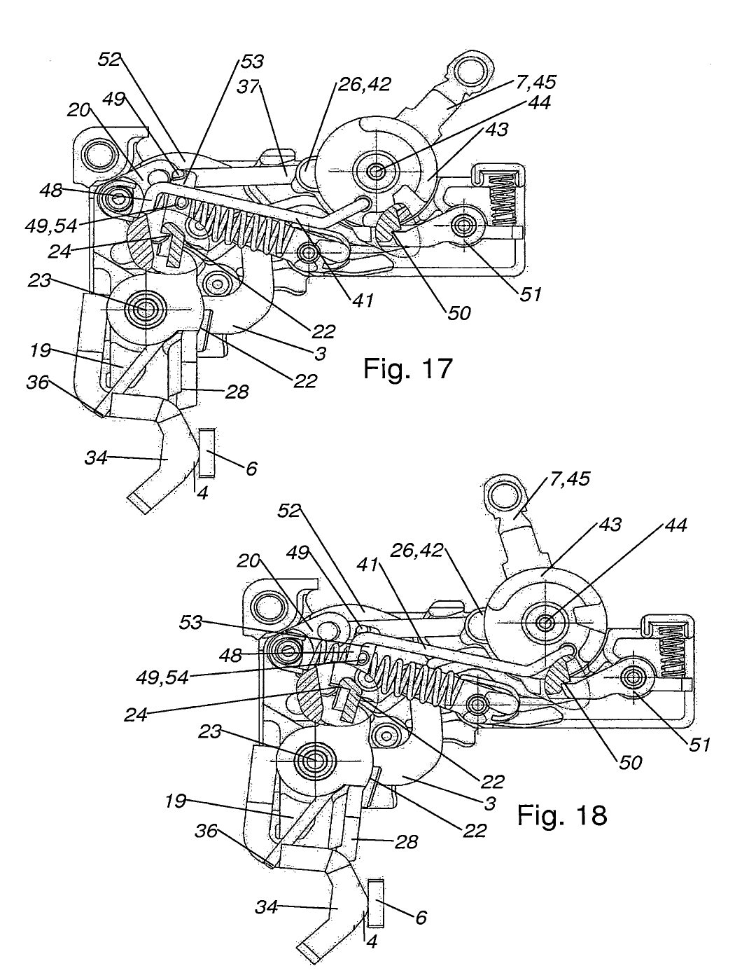

FIG. 12 is an axonometric view of the relevant components. FIGS. 13 to 16 show the activation of the switching device 1 by means of the snap-action activation mechanism 8, and FIGS. 17 to 19 show the deactivation of the switching device 1 by means of the snap-action deactivation mechanism 40.

It should be noted that the switching device 1 according to the invention can trip in the sense of “free tripping” even in the case of a hand lever 7 that is fixed in the position corresponding to the activated state, and that the contacts 4, 6 are separated in the process. The snap-action deactivation mechanism 40 according to the invention relates to the separation of the previously closed contacts 4, 6 brought about manually by operation of the hand lever 7. Irrespective of the term “manual”, this operation can also be carried out by means of an external mechanical actuator that drives the hand lever 7.

According to the preferred embodiment, the pawl bearing surface 22 comprises a guide slot 53 in which the second yoke 41 is arranged so as to be movable in some regions. The second yoke 41 is not rigidly connected to the pawl bearing surface 22, but rather arranged in said guide slot 53 in a longitudinally movable manner. At the same time, the guide slot 53 is preferably formed by two stub-like extensions 49, though it can also have a different design.

The guide slot 53 is preferably arranged in a snap-action tripping extension 55 of the pawl bearing surface 22. The pawl bearing surface 22 is preferably in the form of a lever rotatably or pivotally mounted on the latch rotary spindle 23. One lever arm of this lever-like pawl bearing surface 22 is formed by the tripping extension 28. The second lever arm is formed by the snap-action tripping extension 55, the latch rotary spindle 23 being arranged between the tripping extension 28 and the snap-action tripping extension 55.

The pawl bearing surface 22 preferably also comprises a snap-action tripping stop 54 to be actuated by the second yoke 41, which snap-action tripping stop 54 is preferably arranged at the guide slot 53. In particular, the snap-action tripping stop 54 is formed by one of the preferably two stub-like extensions 49 that together form the guide slot 53.

The second yoke 41 further comprises a shoulder or a hook-shaped end portion 48 for actuating the snap-action tripping stop 54.

The hand lever 7 preferably comprises a first hand lever part 42 and a second hand lever part 43. The handle 45 of the hand lever 7 is arranged on the second hand lever part 43. The two hand lever parts 42, 43 are rotatably arranged about the same hand lever rotary spindle 44. The first yoke 37 is mounted on the first hand lever pat 42 and the second yoke 41 is mounted on the second hand lever part 43.

The first hand lever part 42 and the second hand lever part 43 are formed at least in some regions as rotationally symmetrical bodies. The first and second cams 9, 26, which have already been described in connection with the snap-action activation function, are arranged on the second hand lever part 43. The bearing of the first yoke 37 is also arranged in the region of the second cam 26.

The first hand lever part 42 is preferably mounted inside the second hand lever part 43 in a coaxial manner at least in some regions. In the process, the two hand lever parts 42, 43 are pre-tensioned in terms of their basic position by means of a hand lever spring 46 arranged inside the hand lever 7. FIG. 20 is an exploded view of the hand lever 7 and also shows the hand lever spring 46.

The first hand lever part 42 is rotatable relative to the second hand lever part 43 by a predeterminable angular range. Preferably, the angular range and a length of the second yoke 41 are designed such that the latching between the pawl bearing surface 22 and the pawl 20 is released when the hand lever 7 is arranged in the region of a middle position between an activation position of the hand lever 7 and a deactivation position of the hand lever 7. In this context, the position of the hand lever 7 is preferably determined by the position of the handle 45. In this way, it is possible to produce a particular range within which the handle 45 and thus also the second hand lever part 43 can be moved, without the contacts 4, 6 being separated. This is important in practice in order to prevent slight contact of the handle 45 leading to the switching device 1 being switched off. The middle position is preferably considered to be the middle angular position of the handle 45 between the two positions that correspond to an activated switching device 1 and a deactivated switching device 1. Preferably, said range is ±15° around the middle position. The details described preferably refer to the handle 45 or second hand lever part 43 passing said position. The second hand lever part 43 can thus be moved as far as to the particular position without the contacts 4, 6 being separated. If the second hand lever part 43 moves beyond this position, the contacts 4, 6 are separated abruptly.

FIGS. 17 and 18 each show sub-assemblies of the switching device 1, the contacts 4, 6 being closed in both figures. In FIG. 17, the handle 45 is also in the activated position. FIG. 17 also shows the latching point 24 in a partially cut-away view. Compared with FIG. 17, both the handle and the second hand lever part 43 have been moved anti-clockwise in the view according to FIG. 18. As a result, the hook-shaped end portion 48 of the second yoke 41 now abuts the snap-action tripping stop 54 and has moved said stop slightly further, as shown at the latching point 24. Although the pawl 20 is still latched with the pawl bearing surface 22 and the contacts 4, 6 are closed, the pawl 20 and the pawl bearing surface 22 are still only abutting very slightly. It can be clearly seen by comparing FIGS. 17 and 18 that in each case the first hand lever part 42 is held on the catch projection 50 by the rocking lever 51 and only the second hand lever part 43 has moved.

In the preferred embodiment, the second hand lever part 43 comprises a segment-like cut-out 47, as shown in FIG. 20. The first and second cams 9, 26 of the first hand lever part 42 are arranged in this cut-out 47. The spring inside the hand lever 7 pushes the first hand lever part 42 against the first cam 9 by means of an edge of the segment-like cut-out 47. The second hand lever part 43 can thus be moved about the hand lever rotary spindle 44 relative to the first hand lever part 42.

A catch projection 50 is arranged on the first hand lever part 42. Preferably, the catch projection 50 is arranged in the region of the first cam 9, or adjacently to the first cam 9. When the switching device 1 is activated, the first cam 9 releases the contact arm 3, and so the contacts 4, 6 are closed. Next to the first hand lever part 42, or therebelow in the illustrations, a pivotally mounted rocking lever 51 is arranged as an additional part of the latch 2. The rocking lever 51 engages in the catch projection 50 and holds the first hand lever part 42 firmly in position. The second hand lever part 43 can move relative to the first hand lever part 42 being held firmly by the rocking lever 51, and so the pawl bearing surface 22 is deflected away and the contacts 4, 6 are thus separated when a particular position is passed. The segment-like cut-out 47 on the second hand lever part 43 can thus be designed or sized such that further rotation of the second hand lever part 43 is accordingly possible, without the second hand lever part 43 striking the second cam 26 first.

When the contacts 4, 6 are separated, the contact arm support 19 is also moved. A contact arm support extension 52 is arranged on the contact arm support 19 and pushes the rocking lever 51 away from the catch projection 50 when the contacts 4, 6 are open. During the operation for opening the contacts 4, 6, the rocking lever 51 is thus lifted off the catch projection 50, as a result of which the first hand lever part 42 can pivot back relative to the second hand lever part 43 and the first cam 9 abuts the segment-like cut-out 47 again.

The rocking lever 51 is spring-loaded accordingly, and so it is pushed toward the first hand lever part 42.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A switching device, comprising:
a fixed contact, fixed to a housing, and a movable contact, the movable contact being arranged on a contact arm movably arranged in the switching device, the movable contact being configured to contact the fixed contact being configured to form a conducting current path through the switching device;
a latch, connected to the contact arm, the latch including a pawl and a pawl bearing surface, the pawl bearing surface including a latching point configured to latch the pawl to the pawl bearing surface;
a hand lever, connected to the pawl using a first yoke, configured to bring the movable contact into contact with the fixed contact;
a snap-action deactivation mechanism configured for abrupt separation of the fixed and movable contacts following manual actuation; and
a second yoke, mounted on the hand lever in such a way that actuation of the hand lever for separating the movable contact from the fixed contact releases the latching between the pawl bearing surface and the pawl.

2. The device of claim 1, wherein the pawl hearing surface includes a guide slot in which the second yoke is arranged so as to be movable in some regions.

3. The device of claim 2, wherein the pawl bearing surface includes a snap-action tripping stop configured for actuation by the second yoke.

4. The device of claim 1, wherein the hand lever includes a first hand lever part and a second hand lever part,
wherein the first hand lever part and the second hand lever part are rotatably arranged about the same hand lever rotary spindle,
wherein a handle of the hand lever is arranged on the second hand lever part,
wherein the first yoke is mounted on the first hand lever part, and
wherein the second yoke is mounted on the second hand lever part, and
wherein the first hand lever part is rotatable relative to the second hand lever part about a predeterminable angular range.

5. The device of claim 4, wherein the second yoke has an angular range and a length such that the latching between the pawl bearing surface and the pawl is released when the hand lever is arranged in a position region between an activated position of the hand lever and a deactivated position of the hand lever.

6. The device of claim 4, wherein the first hand lever part and the second hand lever part are formed at least in some regions as rotationally symmetrical bodies.

7. The device of claim 4, wherein the first hand lever part is mounted within the second hand lever part in a coaxial manner at least in some regions.

8. The device of claim 5, further comprising:
a catch projection, arranged on the first hand lever part,
wherein, when the hand lever is in the activated position, the catch projection interacts with a pivotally mounted rocking lever of the latch to thereby keep the hand lever in the activated position.

9 The device of claim 8, wherein the contact arm is connected to a contact arm support of the latch, and
wherein the contact arm support includes a contact arm support extension that pushes the rocking lever away from the catch projection when the fixed and movable contacts are open.

10. The device of claim 1, further comprising:
a snap-action activation mechanism,
wherein the contact arm includes a contact arm extension on an end facing away from the movable contact,
wherein the snap-action activation mechanism includes a rotatably mounted snap-action rocker, controlled by a first cam of the hand lever, and a contact arm catcher configured to contact the contact arm extension, and
wherein the contact arm catcher as a surface hardness that is greater than or equal to a surface hardness of the contact arm extension.

11. The device of claim 10, wherein the contact arm catcher includes metal.

12. The device of claim 10, wherein the contact arm catcher comprises steel.

13. The device of claim 10, wherein the contact support extension is hook-shaped.

14. The device of claim 10, wherein the contact support extension engages behind the contact arm catcher.

15. The device of claim 10, wherein the contact arm catcher is rotationally symmetrical.

16. The device of claim 15, wherein the contact arm catcher is formed as a round rivet and/or a tubular rivet.

17. The device of claim 15, wherein the contact arm catcher is rotatably mounted in the snap-action rocker.

18. The device of claim 10, wherein the snap-action rocker includes a limit stop in a region of the contact arm catcher, and
wherein, when the contact arm extension is engaged with the snap-action rocker, a first contact arm retaining surface abuts the contact arm catcher and a second contact arm retaining surface abuts the limit stop.

19. The device of claim 18, wherein the first contact arm retaining surface is arranged substantially normally to the second contact arm retaining surface.

20. The device of claim 10, wherein the snap-action rocker is formed as a rotatably mounted lever,
wherein the contact arm catcher is arranged on a first lever arm of the snap-action rocker,
wherein a second lever arm of the snap-action rocker is formed as an actuation extension for contacting the first cam of the hand lever.
